(19) United States
(12) Patent Application Publication
(10) Pub. No.: US 2024/0100455 A1
(43) Pub. Date: Mar. 28, 2024

(54) FILTERS WITH ELECTROSTATIC FILTERING CAPABILITIES

(71) Applicant: DelStar Technologies, Inc., Alpharetta, GA (US)

(72) Inventors: Andrew G. Platt, Middletown, DE (US); Yasar Kiyak, Middletown, DE (US); Andrew Scarff, Middletown, DE (US)

(21) Appl. No.: 18/477,474

(22) Filed: Sep. 28, 2023

Related U.S. Application Data
(60) Provisional application No. 63/410,729, filed on Sep. 28, 2022.
(60) Provisional application No. 63/410,731, filed on Sep. 28, 2022.

(51) Int. Cl. B01D 39/16; D01F 6/06; D01F 6/16; D01F 6/62; D04H 1/4282; D04H 1/4291; D04H 1/435; D04H 1/4382; D04H 1/46; D04H 1/56; D04H 3/007; D04H 3/011; D04H 3/105; D04H 3/16

(52) U.S. Cl. CPC B01D 39/1623; D01F 6/06; D01F 6/16; D01F 6/625; D04H 1/4282; D04H 1/4291; D04H 1/435; D04H 1/43835; D04H 1/46; D04H 1/56; D04H 3/007; D04H 3/011; D04H 3/105; D04H 3/16; B01D 2239/0266; B01D 2239/0435; B01D 2239/0618; B01D 2239/0622; B01D 2239/0627; B01D 2239/0636; B01D 2239/10; B01D 2239/1291; D10B 2321/022; D10B 2321/08; D10B 2331/041; D10B 2401/063; D10B 2401/12; D10B 2505/04

(57) ABSTRACT

Filter media, triboelectrically charged fibers thereof, and methods for the same are discussed. The filter media may include a first plurality of fibers and/or a second plurality of fibers. The first plurality of fibers may be triboelectrically charged by the second plurality of fibers. The first plurality of fibers and the second plurality of fibers may include polylactic acid fibers and acrylic acid fibers, respectively. The first plurality of fibers and the second plurality of fibers may also include acrylic fibers and polypropylene fibers, respectively. The filter media may include one or more charge additives. A method for preparing the filter media may include contacting the first plurality of fibers with the second plurality of fibers, where contacting the first and second plurality of fibers with one another triboelectrically charges the first plurality of fibers.

### CROSS-REFERENCE TO RELATED APPLICATIONS

This application claims the benefit of U.S. Provisional Patent Application No. 63/410,729 filed on Sep. 28, 2022 and U.S. Provisional Patent Application No. 63/410,731 filed on Sep. 28, 2022, the contents of which are incorporated herein by reference to the extent consistent with the present disclosure.

### TECHNICAL FIELD

This description generally relates to electrostatic filtration media and more particularly to gas filters incorporating triboelectrically charged fibers.

### BACKGROUND

Conventional filters, such as liquid and gas filters, often utilize or are fabricated from nonwoven materials (e.g., nonwoven and/or porous materials, fibers, textiles, sheets, meshes, etc.) capable of or configured to separate or remove contaminants or particulates (e.g., dust, pollen, mold, bacteria, etc.) from the air. Two types of filtration devices incorporating nonwoven materials include surface filters and depth filters. Surface filters (e.g., membranes or films) act or function as a barrier to prevent the passage of contaminants therethrough. Surface filters typically have a submicron pore size, a relatively narrow pore size distribution, and a relatively high particle capturing efficiency. Surface filters, however, exhibit a relatively high pressure drop that results in reduced airflow through the filter. Surface filters also exhibit a relatively low contaminate (e.g., particles) loading capacity that significantly reduces the longevity of the filter. Accordingly, the application of surface filters are generally limited. Depth filters have a relatively moderate to high efficiency, a relatively low pressure drop, and a relatively high contaminant loading capacity. Depth filters generally employ one or more types of fibers in the form of a nonwoven sheet to form tortuous paths between the fibers to retain or capture the contaminants. While conventional surface and depth filters have a relatively high efficacy in separating contaminants, the physical filtration of the contaminants is often limited by the pore sizes and/or the tortuous paths formed in the nonwoven sheets. In view of the foregoing, the fibers of the nonwoven materials or sheets are often prepared from electrostatically charged fibers to prepare electrostatic or “electret” filter media to further separate contaminants via electrostatic interactions. Electrostatically charged filter media are described in U.S. Pat. Nos. 10,571,137 and 9,802,187, the disclosures of which are incorporated herein by reference to the extent such disclosures are not inconsistent with the present application. Electrostatic or “electret” filter media provide increased filtering efficiency without increasing the amount of force required to push the air through the filter media.

Conventional processes to electrostatically charge the fibers include, but are not limited to, treating the fibers, passing the fibers through a corona (“corona discharge”), hydro-charging, electrostatic fiber spinning, triboelectric charging, or the like. Triboelectric charging, in particular, includes rubbing or otherwise contacting two materials with one another and subsequently separating the materials from one another. While filters utilizing triboelectrically charged filters have shown promise, recent trends have attempted to increase the charge density or the amount of charge that can be produced and maintained on the fibers without compromising the longevity, the loading capacity, the pressure drop, or flow through the filter.

### BRIEF SUMMARY

This following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

The foregoing and/or other aspects and utilities described herein may be achieved by providing a filter media including a first plurality of fibers, where the first plurality of fibers are triboelectrically charged. The first plurality of fibers may include polylactic acid (PLA) fibers or acrylic fibers.

In one aspect, the filter media may include a second plurality of fibers. The first plurality of fibers may be triboelectrically charged with the second plurality of fibers.

In one aspect, at least a portion of the second plurality of fibers may include a tribonegative material.

In one aspect, at least a portion of the second plurality of fibers may include a tribopositive material. The tribopositive material may include a relatively lower positive charge than the first plurality of fibers.

In one aspect, at least a portion of the second plurality of fibers may include polypropylene (PP) fibers.

In one aspect, the polypropylene fibers may include an elongation of from about 25% to about 100%, a tenacity of from about 25 cN/tex to about 100 cN/tex, or a combination thereof.

In one aspect, the first plurality of fibers may include the acrylic fibers.

In one aspect, the first plurality of fibers may include the PLA fibers, and at least a portion of the second plurality of fibers may include acrylic fibers.

In one aspect, the first plurality of fibers may further include polyhydroxyalkanoate (PHBV).

In one aspect, a weight ratio by weight of the first plurality of fibers to the second plurality of fibers may be about 1:1.

In one aspect, the first plurality of fibers and the second plurality of fibers may be non-woven fibers.

In one aspect, the first plurality of fibers may be present in an amount of at least 10 wt %, based on the total weight of the filter media.

In one aspect, the PLA fibers may include poly L-lactide (PLLA).

In one aspect, the first plurality of fibers, the second plurality of fibers, or a combination thereof may include a spin finish of about 2% or lower.

In one aspect, the first plurality of fibers may include continuous fibers.

In one aspect, the first plurality of fibers may include non-continuous fibers.

In one aspect, the first plurality of fibers may have a diameter of from about 0.1 μm to about 200 μm.

In one aspect, the first plurality of fibers may have a linear density of about 0.5 Denier to about 50 Denier.

In one aspect, the first plurality of fibers, the second plurality of fibers, or a combination thereof may include one or more nucleating agents.

In one aspect, the first plurality of fibers, the second plurality of fibers, or a combination thereof may include one or more charge additives configured to modify a charge on the first plurality of fibers, increase a stability of a charge on the first plurality of fibers, or a combination thereof.

In one aspect, the one or more charge additives may include one or more of a triphenylmethane, an ammonium compound, an immonium compound, a fluorinated ammonium compound, a fluorinated immonium compounds, a biscationic acid amide, a polymeric ammonium compound, a diallylammonium compound, an arylsulfide derivative, a phenol derivative, a phosphonium compound, a fluorinated phosphonium compound, a calix(n)arene, a metal complex compound, a benzimidazolone, an azine, a thiazine, an oxazine, or any combination thereof.

In one aspect, the one or more charge additives may include a nucleating agent.

In one aspect, the one or more charge additives may include an electronegative charge relatively greater than the first plurality of fibers or the second plurality of fibers.

In one aspect, the one or more charge additives may include a dielectric constant relatively greater than the first plurality of fibers or the second plurality of fibers.

In one aspect, the first plurality of fibers may include one or more charge control agents.

In one aspect, the filter media may be formed by carding and needling.

In one aspect, the first plurality of fibers and the second plurality of fibers may include spun bond charged media.

In one aspect, the first plurality of fibers and the second plurality of fibers may include melt blown charged media.

In one aspect, the first plurality of fibers may be triboelectrically charged by rubbing the first plurality of fibers with one or more machines. The one or more machines may include one or more of a carding machine, a needling machine, or a combination thereof.

In one aspect, the first plurality of fibers may include the PLA fibers. The first plurality of fibers may be triboelectrically charged by hydrocharging.

In one aspect, the second plurality of fibers may include one or more biodegradable fibers.

In one aspect, the one or more biodegradable fibers may include one or more of poly(3-hydroxybutyrate-co-3-hydroxyhexanoate) (PHBH), polyhydroxybutyrate (PHB), polybutylene succinate (PBS), poly(butyleneadipate-co-terephthalate) (PBAT), poly(3-hydroxybutyrate-co-e-hydroxyvalerate) (PHBV), polyhydroxyalkanoate (PHA), polycaprolactone (PCL), or any combination thereof.

In one aspect, the one or more biodegradable fibers may be selected from the group consisting of poly(3-hydroxybutyrate-co-3-hydroxyhexanoate) (PHBH), polyhydroxybutyrate (PHB), polybutylene succinate (PBS), poly(butyleneadipate-co-terephthalate) (PBAT), poly(3-hydroxybutyrate-co-e-hydroxyvalerate) (PHBV), polyhydroxyalkanoate (PHA), polycaprolactone (PCL), and combinations thereof.

In one aspect, the one or more biodegradable fibers may include PHBH.

The foregoing and/or other aspects and utilities described herein may be achieved by providing an air filter product including any of the foregoing filter media or filter media described herein.

The foregoing and/or other aspects and utilities described herein may be achieved by providing a method for manufacturing a filter media. The method may include contacting a first plurality of fibers that may include polylactic acid (PLA) fibers or acrylic fibers with a second plurality of fibers. Contacting the first plurality of fibers with the second plurality of fibers may triboelectrically charge the first plurality of fibers.

In one aspect, the second plurality of fibers may include a tribonegative material.

In one aspect, the second plurality of fibers may include a tribopositive material. The tribopositive material may include a relatively lower positive charge than the first plurality of fibers.

In one aspect, the second plurality of fibers may include polypropylene (PP).

In one aspect, the first plurality of fibers may include the acrylic fibers.

In one aspect, the first plurality of fibers may include the PLA fibers. The second plurality of fibers may include acrylic fibers.

In one aspect, the first plurality of fibers may further include polyhydroxyalkanoate (PHBV).

In one aspect, a weight ratio of the first plurality of fibers to the second plurality of fibers may be about 1:1.

In one aspect, the first plurality of fibers and the second plurality of fibers may be non-woven fibers.

In one aspect, the filter media may include the PLA fibers in an amount of at least 50 wt %.

In one aspect, the PLA fibers may include poly L-lactide (PLLA).

In one aspect, the method may include carding the first plurality of fibers and the second plurality of fibers.

In one aspect, the method may include spun bonding the first plurality of fibers and the second plurality of fibers.

In one aspect, the method may include melt blowing the first plurality of fibers and the second plurality of fibers.

In one aspect, the method may include contacting one or more nucleating agents with the first plurality of fibers, the second plurality of fibers, or a combination thereof.

In one aspect, the method may include contacting one or more charge additives with the first plurality of fibers, the second plurality of fibers, or a combination thereof.

In one aspect, the method may include contacting one or more charge control agents with the first plurality of fibers, the second plurality of fibers, or a combination thereof.

The foregoing and/or other aspects and utilities described herein may be achieved by providing an air filter product prepared according to any of the foregoing methods.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the present description is not meant to imply or suggest that any or all of these objects may be present as essential features, either individually or collectively, in the most general embodiment of the present description or any of its more specific embodiments.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout this disclosure, ranges are used as shorthand for describing each and every value that is within the range. It should be appreciated and understood that the description in a range format is merely for convenience and brevity and should not be construed as an inflexible limitation on the scope of any embodiments or implementations disclosed herein. Accordingly, the disclosed range should be construed to have specifically disclosed all the possible subranges as well as individual numerical values within that range. As such, any value within the range may be selected as the terminus of the range. For example, description of a range such as from 1 to 5 should be considered to have specifically disclosed subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

As used herein, “free” or “substantially free” of a material may refer to a composition, component, or phase where the material is present in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the composition, component, or phase.

All references cited herein are hereby incorporated by reference in their entireties. In the event of a conflict in a definition in the present disclosure and that of a cited reference, the present disclosure controls.

The present inventors have surprisingly and unexpectedly discovered that polylactic acid (PLA) and/or fibers thereof exhibit and/or possess relatively high tribopositive properties. Accordingly, the present inventors have surprisingly and unexpectedly discovered that rubbing, manipulating, or otherwise contacting the PLA fibers with another fiber or material (e.g., a tribonegative fiber or material) creates or generates significant polarization and/or a charge on the PLA fibers. The generation of the charge creates and/or enhances localized electrical field gradients of or within the filter media and/or the PLA fibers thereof to thereby increase particle removal via electrostatic forces; and thus, increase the filtering efficacy of the filter media. The present inventors have also surprisingly and unexpectedly discovered that the charge on the PLA fibers are retained after aging for several days. The present inventors have further surprisingly and unexpectedly discovered that a fiber blend of PLA fibers and one or more biodegradable fibers, such as PHBV, were capable of preparing filter media that are completely or substantially biodegradable. The present inventors have also surprisingly and unexpectedly discovered that the fiber blend of the PLA fibers and the one or more biodegradable fibers exhibits improved filtering efficacy as compared to conventional filter media that are not biodegradable.

Filter media, filters, and/or fibers thereof that capture particles with electrostatic forces are disclosed. Illustrative filters may be or include, but are not limited to, gas filters, liquid filters, face masks, CPAP filters, vacuum bags, cabin air filters, HVAC furnace filters, gas turbine, compressor air intake filters, panel filters, residential air filters, commercial air filters, and the like. Systems and methods of manufacturing the filter media, the filters, and/or the fibers thereof are also disclosed.

The filter media may include a plurality of fibers. The fibers may be electret fibers. As used herein, the term or expression “electret fibers” may refer to fibers including a dielectric material that has a quasi-permanent state of electric polarization. The plurality of fibers of the filter media may be formed into a substrate, such as a sheet, layer, film, apertured film, mesh, netting, or the like, or any combination thereof. The substrate may include one or more nonwoven materials. For example, the substrate may include fibers or threads that may be interlaid, interlocked, bonded, or otherwise coupled with one another. Illustrative nonwoven materials may be or include, but are not limited to, fibers, layers, sheets or webs bonded or coupled with one another via mechanical, thermal, and/or chemical means or methods. The substrate or the non-woven materials thereof may be meltblown, spunbond, spun lace, heat-bonded, bonded carded, air-laid, wet-laid, co-formed, needle punched, stitched, hydraulically tangled, or the like, or any combination thereof. The substrate may be flat or substantially flat. The substrate may be or include porous sheets prepared from separate fibers, molten plastic or plastic films, or a combination thereof.

The fibers of the filter media may be coupled with one another via mechanical (e.g., entangling), thermal, and/or chemical means. For example, the fibers may be coupled with one another via thermal bonds (e.g., heating). In another example, the fibers may be coupled with one another via one or more chemical bonds. In at least one implementation, the filter media or the fibers thereof may include one or more binding agents, such as an adhesive, capable of or configured to couple the fibers with one another.

The substrate and/or the fibers thereof may be or include a “high loft” nonwoven material. For example, the substrate and/or the fibers thereof may be or include a high loft nonwoven material including spunbond and/or air-through bonded, carded nonwoven fibers. As used herein, the term or expression “high loft” may refer to a nonwoven material or fibers where the volume of void space is relatively greater than the volume of the materials or solids. It should be appreciated that in air-through bonded, carded nonwoven fibers, the loftiness or loft of a substrate may be controlled by various means known to those having ordinary skill in the art. For example, the loft of a material and/or fiber may be increased by applying less compression forces onto the filter media or the fibers thereof during one or more processes (e.g., bonding).

The substrate and/or the fibers thereof may be or include a knitted and/or woven material. The knitted material may include any knitting pattern suitable for the desired application, particularly, filter applications. Suitable knitted materials for filter applications may be or include, but are not limited to, weft-knit, warp knit, knitted mesh panels, compressed knitted mesh, or the like, or any combination thereof. Suitable woven materials for filter applications may be or include textile filter media, such as monofilament fabrics, multifilament fabrics, nylon mesh, polyester mesh, polypropylene mesh, or the like. Woven textiles may be used in, for example, mesh filter press cloths, woven filter pads and other die-cut pieces, centrifuge filter bags, liquid filter bags, dust collector bags, bed dryer bags, rotary drum filters, filter belts, leaf filters, roll media, or the like.

The filter media may include a plurality of fibers that may be triboelectrically charged. It should be appreciated that the triboelectric effect (also known as triboelectricity, triboelectric charging, triboelectrification, or tribocharging) describes electric charge transfer between two objects slid, rubbed, or otherwise contacted with one another. It should also be appreciated that the degree of the triboelectric effect (e.g., the polarity and/or strength of the resulting charge) may be dependent, at least in part, on the respective materials and/or properties thereof, surface morphology (e.g., roughness, smoothness, etc.), temperature, strain (e.g., elastic strain), and the like. It should further be appreciated that a triboelectric series may provide a list of materials ordered by one or more respective properties thereof, such as a respective charge density (nC/cm²) of the materials. Increasing the relatively distance or position of two materials on the triboelectric series indicates a corresponding increase in the charge transfer between the two materials.

The filter media or the fibers thereof may be or include polylactic acid (PLA), a non-PLA polymer, or a combination thereof. For example, the fibers of the filter media may be or include, but are not limited to, polylactic acid (PLA) fibers, one or more non-PLA fibers, or a combination thereof. The PLA fibers may be present in an amount of from about 10 wt % to 100 wt %, based on the total weight of the filter media and/or the fibers thereof. For example, the PLA fibers may be present in an amount of from about 10 wt %, about 20 wt %, about 30 wt %, about 40 wt %, or about 50 wt % to about 60 wt %, about 70 wt %, about 80 wt %, about 90 wt %, about 95 wt % or more, based on the total weight of the filter media or the fibers thereof. In at least one implementation, at least about 10% of the fibers may be PLA fibers. Illustrative PLA fibers may be or include, but are not limited to, racemic polylactic acid, such as poly L-lactide (PLLA), poly D-lactide (PDLA), poly-DL-lactic acid (PDLLA), or the like, or a combination thereof. The PLA polymers or copolymers may be prepared from lactic acid monomer. The lactic acid monomers may be or include, one or more of an isomer of lactic acid, such as L-lactic acid, D-lactic acid, or mixtures thereof, anhydrides of any isomer of lactic acid, including L-lactide, D-lactide, meso-lactide, or mixtures thereof, cyclic dimers of such lactic acids and/or lactides, or the like, or any combination thereof. In an exemplary implementation, the PLA polymer may be a polymer prepared from both L-lactic acid monomers and D-lactic acid monomers.

As used herein, the term or expression “PLA based surfaces” may refer to surfaces of fibers, fabrics, films, or the like, that are made or composed of at least 50% of PLA based resin. It should be appreciated that the remaining portion of the PLA based surfaces may be or be composed of other resins, such as polyhydroxybutyrate (PHB), other biodegradable materials, nucleating agents, antioxidants, charge enhancers, or the like, or any combination thereof. In at least one implementation, the fibers are completely or substantially PLA resin. For example, the fibers may be greater than or equal to about 98% PLA resin, greater than or equal to about 99% PLA resin, or 100% PLA resin. In at least one implementation, at least a portion of the fibers have PLA based surfaces. For example, one or more of the fibers have surfaces including at least 50% of the PLA based resin.

The filter media may include a first plurality of fibers and a second plurality of fibers. The first plurality of fibers may be or include PLA fibers, one or more non-PLA fibers, or a combination thereof. The second plurality of fibers may be or include the PLA fibers, the one or more non-PLA fibers, or a combination thereof. The first and second plurality of fibers may be formed into a substrate, such as a sheet, layer, film, apertured film, mesh, netting, or the like. The substrate may include one or more nonwoven materials. The nonwoven materials may have a structure of individual fibers or threads that may be interlaid. Illustrative nonwoven materials may be or include, but are not limited to, fibers, layers, webs that may be meltblown, spunbond, bonded carded, air laid, wet-laid, co-formed nonwoven structures, hydraulically entangled, or the like, or any combination thereof. The substrate may also be or include, but is not limited to, yarns, felt, knitted or woven fabrics, or the like, or any combination thereof.

The first and second plurality of fibers discussed herein may be included as part of a filter device that separates, traps, captures, or otherwise absorbs contaminants. Illustrative filter devices may be or include, but are not limited to, a liquid filter, a gas filter for home and commercial air filtration, a surgical mask, or other face covering, or the like. The filter device may be a mechanical filter, absorption filter, sequestration filter, ion exchange filter, reverse osmosis filter, surface filter, depth filter, or the like, and may be designed to remove many different types of contaminants from the air, water, or others.

In an exemplary implementation, the first and second plurality of fibers may be incorporated into an air filter that removes or otherwise separates particle and/or contaminants from the air, such as a Minimum Efficiency Reporting Value (MERV) filter, a UV light filter, a washable filter, a medium filter, a spun glass filter, a pleated air filter, an unpleated air filter, an active carbon filters, a pocket filter, a V-bank compact filter, a filter sheet, a flat cell filter, a filter cartridge, or the like. The first and second fibers may include a filter media for the air filter, and may be supported by a support layer, a scrim layer, or may be included in other layers or materials.

In at least one implementation, the first plurality of fibers (i.e., “first fibers”) may include or consist of PLA and/or a derivative thereof. In another implementation, the first plurality of fibers (i.e., “first fibers”) may include a blend or combination of PLA and one or more additional materials or fibers (e.g., non-PLA material or fibers). In yet another implementation, the first plurality of fibers may include or consist of one or more non-PLA materials or fibers (e.g., polypropylene fibers). The additional materials or fibers may be or include, but are not limited to, one or more non-polylactic acid melt-spun fibers, non-melt-spun non-polylactic acid fibers in the form of continuous fibers, staple fibers, bicomponent fibers, acrylic fibers, or the like, or any combination thereof. In at least one implementation, the PLA fibers or composition thereof may include one or more of amine stabilizers, compatibilizers, lubricants, anti-microbial agents, antiviral agents, dispersants, antioxidants, plasticizer, coupling agents, nucleating agents, charge enhancing additives, or the like, or any combination thereof. The PLA may be present in the first plurality of fibers in an amount of at least about 30 wt %, at least about 40 wt %, at least 50 wt %, at least 60 wt %, at least 80 wt %, at least 90 wt %, or more, based on the total weight of the first plurality of fibers.

In at least one implementation, the first fibers may include a blend or combination of PLA fibers and polyhydroxyalkanoate (PHBV) fibers, where the PLA may be present in the first plurality of fibers in an amount of at least about 50% by weight of the first fibers. The first fibers including a blend or combination of PLA fibers and PHBF fibers may have a charge density of about 0.5 nC/cm² or greater.

In at least one implementation, the first plurality of fibers includes polypropylene (PP) fibers and the second plurality of fibers includes acrylic fibers. Accordingly, the filter media or the fibers thereof includes a first plurality of fibers including PP fibers, a second plurality of fibers including acrylic fibers, and the filter media or the fibers thereof further includes one or more charge additives, as further discussed herein.

In at least one implementation, the first plurality of fibers and/or the second plurality of fibers have a tenacity or tensile strength of from about 25 cN/tex to about 100 cN/tex. For example, the first fibers and/or the second fibers may have a tenacity of from about 25 cN/tex, about 35 cN/tex, or about 45 cN/tex to about 50 cN/tex, about 70 cN/tex, about 80 cN/tex, or about 100 cN/tex. In another example, the first fibers and/or the second fibers may have a tenacity of from about 25 cN/tex to about 100 cN/tex, about 35 cN/tex to about 60 cN/tex, or about 45 cN/tex. In at least one implementation, the first plurality of fibers includes PP fibers, and the first plurality of fibers or the PP fibers thereof have a tenacity of about 25 cN/tex to about 100 cN/tex, about 30 cN/tex to about 60 cN/tex, or about 45 cN/tex. As used herein, the term or expression “tenacity” may refer to the mass stress at break.

In at least one implementation, the first plurality of fibers and/or the second plurality of fibers have an elongation of from about 10% to about 150%. For example, the first fibers and/or the second fibers may have an elongation of from about 10%, about 20%, about 30%, or about 35% to about 40%, about 50%, about 70%, about 80%, or about 150%. In another example, the first fibers and/or the second fibers may have an elongation of from about 10% to about 100%, about 20% to about 70%, about 30% to about 40%, or about 35%. In at least one implementation, the first plurality of fibers includes PP fibers, and the first plurality of fibers or the PP fibers thereof have an elongation of from about 10% to about 150%, about 20% to about 100%, about 30% to about 40%, or about 35%. As used herein, the term or expression “elongation” may refer to the amount of extension or stretch that a fiber or fiber accepts before it breaks.

In an exemplary implementation, the first plurality of fibers and/or the second plurality of fibers has a tenacity of about 25 cN/tex to about 100 cN/tex, about 30 cN/tex to about 60 cN/tex, or about 45 cN/tex, and an elongation of about 25% to about 100%, about 30% to about 50%, or about 35%. The present inventors have surprisingly and unexpectedly discovered that fibers having a tenacity of about 30 cN/tex to about 60 cN/tex, or about 45 cN/tex, and an elongation of about 30% to about 40%, or about 35%, exhibited increased efficacity for holding and/or generating a triboelectric charge. Without being bound by theory, it is believed that the relatively high tenacity and/or relatively low elongation results in the fibers being drawn more than typical. The relative increase in the drawing of the fibers is believed to affect crystallization. Particularly, the relative increase in the drawing of the fibers is believed to increase the amount or percentage of crystallization, thereby resulting in more ordered or oriented crystals, and the orientation of the crystals result in the relative increased efficacy of the fibers for generating and/or holding a triboelectric charge.

In at least one implementation, the first fibers and/or the second fibers may have a spin finish of 2% or lower, and preferably no or substantially no spin finish (e.g., naked fibers). As used herein, the term or expression “spin finish” may refer to a liquid, solid, or emulsion composition that is applied to the surfaces of fibers in order to improve the processing of the fibers, such as in short-staple or long-staple spinning.

The first plurality of fibers, which may include the PLA fibers, may be continuous or non-continuous. Illustrative non-continuous fibers may be or include, but are not limited to staple fibers. The first plurality of fibers (e.g., staple and/or continuous fibers) may have a length of from about 1 mm to about 200 mm, about 5 mm to about 150 mm, or about 30 mm to about 70 mm. The first plurality of fibers may have a diameter of from about 0.1 microns to about 200 microns, or from about 5 microns to about 50 microns. The first plurality of fibers may have a linear density of from about 0.5 Denier to about 50 Denier.

In at least one implementation, the second plurality of fibers may be or include, but are not limited to, a tribonegative material or a tribopositive material with or having a relatively low charge density as compared to the first plurality of fibers (e.g., the PLA fibers). As discussed above, the present inventors have surprisingly and unexpectedly discovered that PLA and fibers thereof are a relatively high tribopositive material. For example, PLA is a tribopositive material having a charge density of from about 0.5 to 1.0 nC/cm². As such, PLA presents a relatively improved material to transfer charge with a tribonegative material, and rubbing or contacting the first plurality of fibers, which may include the PLA fibers, with the second plurality of fibers including fibers or materials positioned sufficiently away from PLA on a triboelectric series results in significant polarization and charge on the PLA fibers.

The non-PLA fibers and/or the second plurality of fibers (i.e., “second fibers”) may be or include artificial fibers, natural fibers, or a combination thereof. Illustrative materials and/or fibers for the non-PLA fibers and/or the second plurality of fibers may be or include, but are not limited to, polypropylene, polyesters (PET), polyethylene naphthalate (PEN) polyester, polycyclohexylene dim ethyl ene terephthalate (PCT) polyester, polypropylene (PP), polybutylene terephthalate (PBT) polyester, co-polyamides, polyethylene, high density polyethylene (HDPE), linear low density polyethylene (LLDPE), cross-linked polyethylene, polycarbonates, polyacrylates, polyacrylonitriles (PAN), polyfumaronitrile, a polymer prepared from fumaronitrile, polystyrenes (PS), styrene maleic anhydride, polymethylpentene, cyclo-olefinic copolymers, fluorinated polymers, polytetrafluoroethylene, perfluorinated ethylene and hexfluoropropylene or a copolymer with PVDF, such as P(VDF-TrFE) or poly(vinylidene fluoride-co-trifluoroethylene) copolymer with 80% molar VDF content, or terpolymers, such as P(VDF-TrFE-CFE), propylene, polyimides (PI), Kevlar, polyether ketones, cellulose ester, cotton, ramie, chitosan, wool, cuprammonium rayon (cupro), Lyocell, nylon, polyamides, silk, polyether-polyurea copolymers, Lycra, elastane, polymethacrylic polymers, poly(methyl methacrylate), polyoxymethylene, polysulfonates, acrylic, modacrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymers, phenolic, polyurethane, cellulose, polytetrafluoroethylene (PTFE), styrene, or any combination thereof. It should be appreciated that other conventional fiber materials may be contemplated.

The filter media and/or the fibers thereof may be biodegradable or substantially biodegradable. As used herein the term “biodegradable” may refer to a material or substance that may be decomposed by microorganisms. The filter media and/or the fibers thereof may also be bio-based or substantially bio-based. As used herein, the term or expression “bio-based material” may refer to a material or substance made or prepared from substances derived from living (or once living) organisms. For example, bio-based materials may refer to materials and substances resulting from plant and or animal biomass. Illustrative bio-based materials may be or include, but are not limited to, materials derived and/or prepared from starches, sugars, lipids extracted from corn, sugar cane, sugar beets, plant oils, or the like, or any combination thereof.

In at least one implementation, the non-PLA fibers and/or the second plurality of fibers may be or include, but are not limited to one or more biobased and/or biodegradable fibers. For example, a portion of the non-PLA fibers and/or the second plurality of fibers may be or include one or more biobased and/or biodegradable fibers. In another example, the non-PLA fibers and/or the second plurality of fibers may be substantially or completely biobased and/or biodegradable fibers. Illustrative biobased and/or biodegradable fibers may be or include, but are not limited to, one or more polymers and/or fibers prepared from or including poly(3-hydroxybutyrate-co-3-hydroxyhexanoate) (PHBH), polyhydroxybutyrate (PHB), polybutylene succinate (PBS), poly(butyleneadipate-co-terephthalate) (PBAT), poly(3-hydroxybutyrate-co-e-hydroxyvalerate) (PHBV), polyhydroxyalkanoate (PHA), polycaprolactone (PCL), polycaprolactone butylene succinate (PCL-BS), polybutylene succinate adipate (PBSA), polyethylene terephthalate succinate (PETS), cellulose acetate (CA), one or more petroleum-based biodegradable polymers, derivatives thereof, copolymers thereof, or any combination thereof.

In an exemplary implementation, the filter media may include the first plurality of fibers including PLA fibers, which are biobased and biodegradable, and the second plurality of fibers may include one or more additional biobased and/or biodegradable fibers. For example, the filter media may include a blend of the PLA fibers and one or more additional biobased and/or biodegradable fibers. In another example, the filter media may include a blend of the PLA fibers and the additional biobased and/or biodegradable fibers including one or more of PHBH, PHB, PBS, PBAT, PHBV, PHA, or any combination thereof. In yet another example, the filter media may include a blend of the PLA fibers and one or more additional biobased and/or biodegradable fibers selected from the group consisting of PHBH, PHB, PBS, PBAT, PHBV, PHA, and a combination thereof. In another example, the filter media may include a blend of the PLA fibers and PHBH.

The non-PLA fibers and/or the second plurality of fibers or second fibers may have a thickness or diameter of from about 1 μm to about 10,000 μm, about 1 μm to about 1,000 μm, or about 10 μm to about 100 μm. For example, the second fibers may have a diameter of from about 0.1 μm to about 200 μm or from about 5 μm to about 50 μm.

In an exemplary implementation, the first plurality of fibers may be or include PLA and/or PLA fibers, and the second plurality of fibers may be or include polypropylene fibers, acrylic fibers, or a combination thereof. It should be appreciated that PLA has several properties or qualities that are similar to PP, PE, and PS, including but not limited to, dielectric constant, tangent loss, and surface resistivity. PLA, however, transfers relatively more charge when rubbed or contacted with PP fibers than acrylic fibers. Similarly, PLA transfers relatively more charge when rubbed or contacted with acrylic fibers than PP fibers. In view of the foregoing, utilizing the first plurality of fibers including PLA or PLA fibers with the second plurality of fibers including one or more sufficiently tribonegative materials and/or tribonegative fibers increases the efficacy of the filter media without compromising other properties/qualifies of the filter media, such as longevity, loading capacity (e.g., dust holding capacity), pressure drop, airflow through the filter media, or the like, or any combination thereof. It should also be appreciated that PLA has a relatively higher electrical resistance and a relatively lower coefficient of friction as compared to polypropylene (PP). PLA and fibers thereof are also hydrophobic. PLA is also biodegradable. PLA may be produced or prepared from already existing manufacturing equipment, such as those used for petrochemical industrial plastics. As such, the production of PLA and/or fibers thereof may be relatively cost-effective as compared to other polymers (e.g., PP, PS, PE, etc.).

The first plurality of fibers and the second plurality of fibers may have the same linear mass densities, as measured in denier or den (D). The first plurality of fibers and the second plurality of fibers may also have different linear mass densities. In at least one example, the second plurality of fibers may have a linear mass density of from about 0.5 denier or den (D) to about 50 D, about 1 D to about 10 D.

The first fibers and the second fibers may be present in the filter media in a weight ratio of about 10:1 (e.g., about 10 to about 1), about 5:1, about 3:1, about 2:1, about 1:1, about 1:2, about 1:3, about 1:5, or about 1:10. In an exemplary implementation, the weight ratio of the first fibers to the second fibers is about 1:1.

The first fibers and the second fibers may be present in the filter media in a total surface area ratio of about 10:1, about 5:1, about 3:1, about 2:1, about 1:1, about 1:2, about 1:3, about 1:5, or about 1:10. In an exemplary implementation, the total surface area ratio of the first fibers to the second fibers is about 1:1.

PLA possesses several important qualities that are similar to PP, such as dielectric constant, tangent loss, and surface resistivity. PLA, however, transfers more charge when rubbed against PP than, for example, rubbing acrylic fibers against PP. Likewise, PLA transfers more charge when rubbed against acrylic fibers than, for example, rubbing acrylic fibers against PP. In other words, PLA has more triboelectric charge density than PP and acrylic fiber. Thus, PLA increases the overall effectiveness of the triboelectrically charged filter without compromising other functions, such as longevity, loading capacity (e.g., dust holding capacity), the pressure drop, or air flow through the filter. As used herein, the term or expression “pressure drop” of a filter, a media, or material thereof may refer to the decrease in pressure from an upstream side to a downstream side of the filter, media, or material thereof.

The PLA fibers and/or the second fibers may be continuous or non-continuous (e.g., staple). In embodiments, the PLA fibers may have a diameter of from about 0.1 microns to about 200 microns, or from about 5 microns to about 50 microns. The PLA fibers may have a linear density of from about 0.5 Denier to about 50 Denier.

The PLA fibers and/or the second fibers may include one or more nucleating agents that facilitate the formation of polymer crystals in the fibers. Suitable nucleating agents may be or include, but are not limited to, inorganic additives, organic additives, polymers, or the like or any combination thereof.

The filter media and/or the one or more fibers of the filter media may include one or more charge additives or charge control agents (CCA). For example, the filter media, the first plurality of fibers thereof, and/or the second plurality of fibers thereof may include one or more charge additives or charge control agents. The one or more charge additives may be capable of or configured to modify (e.g., increase or decrease) a triboelectric charge of the filter media and/or the one or more fibers thereof. The one or more charge additives may also be capable of or configured to increase the stability and/or duration of the triboelectric charge of the filter media and/or the one or more fibers thereof. The one or more charge additives may be capable of or configured to modify the triboelectric charge, increase the stability, and/or increase the duration of the triboelectric charge without compromising other characteristics or properties of the filter media, including, longevity, loading capacity, and/or pressure drop. In at least one example, the first plurality of fibers, which may include the PLA fibers, and/or the second plurality of fibers may include the one or more charge additives or charge control agents (CCA). In another example, the first plurality of fibers, which may include the non-PLA fibers, and/or the second plurality of fibers may include the one or more charge additives or charge control agents (CCA). In yet another example, the first plurality of fibers, which may include a combination of the PLA fibers and the non-PLA fibers, and/or the second plurality of fibers may include the one or more charge additives or charge control agents (CCA). The charge additives may be present in the one or more fibers of the filter media in an amount of from about 0.02 wt % to 33 wt %, based on the total weight of the filter media or the one or more fibers thereof.

The charge additives may be or include, but are not limited to, triphenylmethanes, ammonium compounds, immonium compounds, fluorinated ammonium compounds, fluorinated immonium compounds, biscationic acid amides, polymeric ammonium compounds, diallylammonium compounds, arylsulfide derivatives, phenol derivatives, phosphonium compounds, fluorinated phosphonium compounds, calix(n)arenes, metal complex compounds, benzimidazolones, azines, thiazines, oxazines, or the like, or any combination thereof. Illustrative charge additives may also be or include, but are not limited to, one or more nucleating agents having a surface charge that is opposite to the partial charge of the polymer, such as magnesium stearate (MgSt), phosphonium salts (e.g., triphenyl phosphine, tributyl phosphine, trimethyl phosphine, dimethyl phenyl phosphine, methyl diphenyl phosphine, tris(2-ethylhexyl) phosphine, tetrabutyl-phosphonium hexafluorophosphate, tetrabutyl-phosphonium-hydrogen sulfate, and tetrabutylammonium-phenylphosphonate), pyridinium salts (e.g., tritylpyridinium tetrafluoroborate), pyrrolidinium salts (e.g., 1-butyl-1-methylpyrrolidinium bromide), sulfonium (e.g., triphenylsulfonium tetrafluoroborate), sulfonate sodium octyl sulfonate), phosphonate (e.g., phosphonic acids, esters, and salts; phosphinic acid, esters, and salts; phosphonamides; phosphinamides) phosphonate (e.g., tetrabutylammonium-phenylphosphonate), or the like, or any combination thereof. Illustrative charge additives may also include, but are not limited to, one or more high dielectric constant articles, such as CaCu3Ti₄O₁₂, BaTiO₃ and TiO₂, more electronegative articles than PP such as PTFE and silicon, articles with ultra-low dielectric loss tangent property, such as silicon nitride, alumina, ceramic, high density polyethylene, or the like, or any combination thereof. Illustrative charge additives may also be or include, but are not limited to, metal salt of aluminum or magnesium, lead zirconate titanate, potassium niobate, lithium niobate, lithium tantalate, sodium tungstate, unsaturated carboxylic acid or derivative thereof, unsaturated epoxy monomer or silane monomer, maleic anhydride, monoazo metal compound, alkyl acrylate monomers, alkyl methacrylate monomers, polytetrafluoroethylene, alkylene, arylene, arylenedialkylene, alkylenediarylene, oxydialkylene or oxydiarylene, polyacrylic and polymethacrylic acid compound, organic titanate, quaternary phosphonium trihalozincate salts, organic silicone complex compound, dicarboxylic acid compound, cyclic polyether or non-cyclic polyether and cyclodextrin, complex salt compound of the amine derivative, ditertbutylsalicylic acid, potassium tetraphenylborate, potassium bis borate, sulfonamides and metal salts, cycloalkyl, alumina particles treated with silane coupling from group consisting of dimethyl silicone compound, azo dye, phthalic ester, quaternary ammonium salt, carbazole, diammonium and triammonium, hydrophobic silica and iron oxide, phenyl, substituted phenyl, naphthyl, substituted naphthyl, thienyl, alkenyl and alkylammonium complex salt compound, sodium dioctylsulfosuccinate and sodium benzoate, zinc complex compound, mica, monoalkyl and dialkyl tin oxides and urethane compound, metal complex of salicylic acid compound, oxazolidinones, piperazines or perfluorinated alkane, lecigran MT, nigrosine, fumed silica, carbon black, para-trifluoromethyl benzoic acid and ortho-fluoro benzoic acid, poly(styrene-co-vinylpyridinium toluene sulfonate), methyl or butyltriphenyl complex aromatic amines, triphenylamine dyes and azine dyes, alkyldimethylbenzylammonium salts, or the like, or any combination thereof. In an exemplary implementation, the charge additive may include an electret additive with the tradename FWM02™, which is commercially available from Keimei Plastifizierung Technik (Yantai) Co., Ltd. of Shandong Province, China. FWM02™ increases the charge density on the surface of the fiber to thereby increase the charge holding period thereof. FWM02™ may increase the melt strength of the fiber as compared to fibers without the charge additive. Increasing the melt strength of the fibers with the charge additive FWM02™ may reduce the relative amount of defects (e.g., melt shot, broken fibers, etc.) to thereby increase the ability of the fibers to hold and/or generate charge. FWM02™ has a bulk density of from about 0.50 g/cm³ to about 0.55 g/cm³, a granular weight of from about 60 ea/g to about 65 ea/g, a filter pressure value (FPV) of less than or equal to 0.5 bar/g, a pressure rising value (PRV) of less than or equal to about 0.5 Pa/g, and/or a melt flow index of about 650-655 g/10 min. In another implementation, the charge additive may include an electret additive with the tradename CON-CHARGE 01585, which is commercially available from CONSTAB Polyolefin Additives GmbH of Ruthen, Germany. Illustrative charge control agents may be or include, but are not limited to, one or more metal salts of aluminum or magnesium, lead zirconate titanate, potassium niobate, lithium niobate, lithium tantalate, sodium tungstate, unsaturated carboxylic acid or derivative thereof, unsaturated epoxy monomer or silane monomer, maleic anhydride, a monoazo metal compound, alkyl acrylate monomers, alkyl methacrylate monomers, polytetrafluoroethylene, alkylene, alkylene-based CCAs, arylene, arylene-based CCAs, arylenedialkylene, alkylenediarylene, silicon nitride, PTFE, tourmaline, acid anhydride, maleic anhydride, alkylene glycol, polyethylene glycol, PDLA, CTL-01 and CN-L01 by Polyvel, Talc (Jetfine by Imerys or SK-9900 by Liaoniing Jinghua New Materials), N′1,N′6-dibenzoyladipohydrazide (TMC-306 by Shanxi Chemical research), aromatic sulfonate derivatives (LAK 301 by Takemoto Oil and Fat Co. Ltd.), sorbitol (SORB by Euro OTC Pharma Gmbh), polyethylene glycol, NA 5516 by Sukano, NC PL830 by KRITILEN, MAXITHEN® BIOL by Gabriel-Chemie, dioctyl adipate, ethylene bisstearamide, zinc phenyl phosphonate (PPZn), ECOPROMOTE® by Nissan chemical, or the like, or any combination thereof. The one or more charge additives may also be or include, but are not limited to, an electret additive having the tradename MagIQ™, which is commercially available from Avient of Avon Lake, OH, USA. Additional CCAs that may be utilized may be found in U.S. Pat. No. 10,571,137, the contents of which are incorporated herein to the extent consistent with the present disclosure. The charge additive may include any combination of the foregoing.

The filter media, the first plurality of fibers thereof, and/or the second plurality of fibers thereof may include the charge control agents in an amount of from about 0.02 wt % to about 33 wt % based on the total weight of the filter media, the first plurality of fibers thereof, and/or the second plurality of fibers. For example, the filter media, the first plurality of fibers thereof, and/or the second plurality of fibers thereof may include the charge control agents in an amount of from about 0.2 wt %, about 1 wt %, about 5 wt %, about 10 wt %, or about 15 wt % to about 20 wt %, about 25 wt %, about 30 wt %, or about 33 wt %, based on the total weight of the filter media, the first plurality of fibers thereof, and/or the second plurality of fibers.

The first plurality of fibers and/or the second plurality of fibers may include one or more waxes. Illustrative waxes may be or include, but are not limited to, one or more of polyolefin, polyethylene, functionalized wax, such as amines, amides, fluorinated waxes, mixed fluorinated and amide waxes, such as esters, quaternary amines, carboxylic acids or acrylic polymer emulsion, chlorinated polyethylenes, natural or synthetic ester waxes, carnauba wax, paraffin, or the like, or any combination thereof. The one or more waxes may be fractionated or distilled to provide specific cuts that meet certain viscosity and/or temperature criteria.

The filter media, the first plurality of fibers thereof, the second plurality of fibers thereof, and/or the substrate thereof may include one or more additives. Illustrative additives may be or include, but are not limited to, one or more antibacterial agents or compositions, one or more antiviral agents or compositions, or a combination thereof. Illustrative antibacterial and antiviral agents or compositions may be or include, but are not limited to, silver, zinc, copper, organosilicon, tributyl tin, compounds thereof, complexes thereof, one or more organic compounds, such as organic compounds including one or more of chlorine, bromine, fluorine, or any combination thereof.

The PLA fibers may be poly L-lactide (PLLA), poly D-lactide (PLDA), or a combination thereof. In at least one implementation, the second fibers may be or include a tribonegative material. In at least one implementation, the second fibers may include polypropylene (PP) and/or acrylic fibers.

In at least one implementation, the weight ratio of the first fibers to the second fibers is about 1:1. In at least one implementation, the first fibers and/or the second fibers have a spin finish of about 2% or less, preferably no or substantially no spin finish.

The fibers contemplated may have one or more shapes in cross-section, including without limitation, circular, kidney bean, dog bone, trilobal, barbell, bowtie, star, Y-shaped, or the like. It should be appreciated that the cross-sectional shape of the fibers may be selected and/or may be at least partially dependent on one or more performance characteristics of the filter media and/or the one or more fibers thereof.

The filter media and/or the fibers thereof may be or have a gradient density. For example, the filter media and/or the fibers thereof may be prepared or configured as a filter media and/or fiber sheet having a gradient density, where one or more properties thereof is modified (e.g., increased or decreased) from one side or surface to an opposing side or surface thereof. For example, the filter media and/or the fibers thereof may have pore sizes that increases or decreases from an upper surface (e.g., upstream side) to a lower surface (e.g., downstream side). In an exemplary implementation, the filter media and/or the fibers sheets thereof have pore sizes that decreases from the upper surface (e.g., upstream side) to the lower surface (e.g., downstream side) thereof. It should be appreciated that varying the gradient density of one or more properties of the filter media and/or the fibers thereof may modify (e.g., increase) the loading capacity, the efficacy, and/or efficiency of the filter media of the fibers thereof. Additional properties of the filter media and/or the fibers thereof that may be modified according to a gradient may be or include, but are not limited to, length of the fibers, thickness or diameter of the fibers, relative composition of respective fibers in a blend, charge density of the fibers, or the like, or any combination thereof.

The filter media and/or the fibers thereof may include one or more bicomponent fibers. As used herein, the term or expression “bicomponent fiber” refers to fibers that includes at least two materials bound or otherwise coupled with one another. For example, the filter media and/or the fibers thereof may be or include one or more bicomponent fibers. Bicomponent fibers may be prepared by extruding two materials (e.g., polymers) form the same spinneret. Illustrative combinations of materials for the bicomponent fibers may be or include, but are not limited to, polypropylene (PP)/polyethylene (PE), polyethylene terephthalate (PET)/polypropylene (PP), or the like, or any combination thereof. As further discussed herein, the one or more fibers of the filter media and/or the fibers (e.g., plurality of fibers) thereof may be coupled with one another via thermal bonding, chemical bonding, and/or mechanical bonding (e.g., entanglement).

A method for manufacturing a filter media may include providing or preparing a plurality of polylactic acid (PLA) fibers, and triboelectrically charging the PLA fibers. The method may include triboelectrically charging the PLA fibers with a plurality of second fibers or the second fibers.

The fibers may be manufactured or prepared by any method, including, without limitation, an air laid method, wet-laid, extrusion, co-formed, needle punched, stitched, hydraulically entangled, meltblown, spunbond, spun lace, heat-bonded, carded, spinneret, gel spinning, melt spinning, wet spinning, dry spinning, islands-in-a sea staple or spunbond, segmented pie staple or spunbond, electrospinning, or the like, or any combination thereof. The foregoing and/or additional methods for preparing or manufacturing the fibers are described in U.S. Pat. Nos. 4,406,950, 6,338,814, 6,616,435, 6,861,142, 7,252,493, 7,300,272, 7,309,430, 7,422,071, 7,431,869, 7,504,348, 7,774,077, 9,522,357, 9,993,761, and U.S. Patent Publication No. 2009/266,759, the disclosures of which are hereby incorporated herein by reference for all purposes and to the extent consistent with the present disclosure.

In an exemplary implementation, the system, the filter media, and/or the fibers thereof may include a spunbond line or fiber. The spunbond fiber or filament may be prepared or formed by spinning a molten polymer into a fiber or filament, and stretching the molten fiber. The fibers may be prepared as fiber bundles that may be separated, spread, and/or layered on a net to form a web. The fibers may also be bound in the form of a sheet or film through thermal bonding and embossing.

In another exemplary implementation, the system, the filter media, and/or the fibers thereof may include fibers prepared with or formed from melt blowing dies. Examples of suitable melt-blowing dies that may be utilized for are discussed in more detail in U.S. Pat. Nos. 6,972,104, 8,017,534, and 7,772,456 and U.S. Patent Application No. U.S. 2020/0216979A1, the complete disclosures of which are incorporated herein by reference in their entirety for all purposes and to the extent consistent with the present disclosure.

In an exemplary implementation, the system for preparing the filter media and/or the fibers thereof may include one or more carding machines. For example, the system may include two carding machines disposed in series relative to one another. The fibers having short fiber lengths may be processed through or by fiber opening, blending, and/or consolidation into a continuous fibrous web. The fibrous web prepared from carding may be subjected to one or more additional processes. For example, the fibrous web may be subjected to a secondary process of bonding improve or increase integrity and/or strength of the fibrous web. It should be appreciated that the process of bonding may be accomplished via chemical, thermal, and/or mechanical methods.

In at least one implementation, the electrostatic or electret substrate prepared from the fibers may be a high loft triboelectric filter media prepared by carding and needling. In at least one implementation, the method may include needling the fibers. The method may further include carding the fibers. In other embodiments, the method may include spun bonding the fibers. In yet other embodiments, the method may include melt-blowing the fibers.

In at least one implementation, the method may include contacting the first fibers and/or the second fibers with one or more nucleating agents, charge additives, charge control agents, or a combination thereof. For example, the method may include adding or otherwise contacting one or more nucleating agents with the first fibers and/or the second fibers. In another example, the method may include adding or otherwise contacting one or more charge additives with the first fibers and/or the second fibers. In yet another example, the method may also include adding or otherwise contacting one or more charge control agents with the first fibers and/or the second fibers.

In at least one implementation, the filter media, the first plurality of fibers (e.g., the PLA fibers), and/or the second plurality of fibers may be produced or prepared with a dual beam melt blowing system. The dual beam melt blowing system may be oriented at an angle such that two fiber streams of the dual beam melt blowing system may intermingle or otherwise contact one another, and then triboelectrically charge one or more of the fibers. For example, the two fiber streams of the dual beam melt blowing system may intermingle or otherwise contact one another, and thereby triboelectrically charge one or more of the fibers. It should be appreciated that the fibers (e.g., the first plurality of fibers and/or the second plurality of fibers) may be triboelectrically charged via needling, creating vibrations, or hydroentangling.

In this embodiment, the triboelectrically charging method might be needling, creating vibrations, or hydroentangling.

In at least one implementation, the filter media, the first plurality of fibers (e.g., the PLA fibers), and/or the second plurality of fibers may be produced by melt blowing techniques and then triboelectrically charged. For example, low viscosity PLA resin may be extruded via a melt blowing die to prepare PLA fibers. The melt blown PLA fibers may be triboelectric charged via a hydroentanglement (i.e., hydro-charging) process where clean water function or act as a second component for creating friction on the PLA fiber or the surface thereof.

In at least one implementation, the filter media and/or the fibers thereof may include bicomponent fibers including two or more materials. The bicomponent fibers may be spunbond or melt blown. In an exemplary implementation, a first material of the bicomponent fibers includes PLA. The second material of the bicomponent fibers may be selected from one or more of the materials disclosed herein. It should be appreciated that the bicomponent fibers may have varying cross-sections, such as, side by side, segmented pie, hollow segmented pie, segmented ribbon, or the like, or any combination thereof. The bicomponent fibers may be triboelectrically charged via vibrations, needling, hydroentangling, or the like, or any combination thereof.

In at least one implementation, the filter media and/or the fibers thereof may be contacted or otherwise rubbed with any suitable material to triboelectrically charge the filter media and/or the fibers thereof. For example, PLA articles, such as fiber, films or fabrics, may be rubbed against any suitable materials disclosed herein, and frictional energy (e.g., mechanical) may be transferred into the electrical energy. This system, commonly called known as triboelectric nanogenerators (TENG), converts mechanical energy harvested from the environment to electricity for powering small devices, such as sensors, air filtration, or for recharging consumer electronics. Triboelectrically charged PLA surfaces may be excellent materials for TENG systems since PLA has a high charge density for triboelectrification.

The first and/or the second fibers may include one or more polymers that may include one or more charge additives, charge enhancers, and/or charge control agents. The charge additives, enhancers, and/or control agent may be capable of or configured to retain or enhance the triboelectric charge in the filter or the fibers thereof. The charge additives may be added to the fibers in any suitable conventional manner. For example, the charge additives may be added to polypropylene fibers by mixing, combining, adding, or otherwise contacting the charging additives in particulate form (e.g., powders and/or granules) to a melt of the polymers just before extruding the melt and mixing thoroughly. Therefore, the charge additive particles that are suspended and well-distributed in the melt are, to some degree, found at the surface of the fibers after extrusion.

The second fibers may include polypropylene (PP), an acrylic polymer, or a combination thereof. In at least one implementation the second fibers may include a blend of polypropylene (PP) and acrylic fibers. In another implementation, the second fibers may include a blend of PP and an additional polymer. In yet another implementation, the second fibers may include a blend of an acrylic polymer and an additional polymer. The additional polymer may be or include any polymer disclosed therein, including those disclosed with respect to the second fibers.

The one or more fibers of the filter media may include a homopolymer or copolymer or a heterofilament, which is a bicomponent fiber wherein one of the components is an electret. In one example, the one or more fibers of the filter media may include a homopolymer of PP. In another example, the one or more fibers of the filter media may be a PP fiber. In another example, the one or more fibers of the filter media may be a bicomponent fiber including PP and an additional polymer and/or electret. For example, the one or more fibers of the filter media may be a bicomponent fiber including PP and an electret.

The one or more fibers of the filter media may include melt-spun fibers, or non-meltspun fibers in the form of continuous fibers, staple fibers, bicomponent fibers, or the like. In an exemplary implementation, the one or more fibers of the filter media are staple fibers and have a spin finish of 2% or lower, preferably no or substantially no spin finish (i.e., naked staple fibers).

In an exemplary implementation, at least some of the fibers may include one or more polymers that may include a charge additive, charge enhancer or charge control agent such as those described above and at least some of the fibers may include PLA. The PLA fibers may include, for example, Racemic PLLA (poly L-lactide), regular PLLA, poly D-lactide (PLDA), poly-DL-lactic acid (PDLLA), or a combination thereof. Furthermore, PLA based surfaces here refer to the surfaces of fibers, fabrics, or films made of at least 50% of PLA based resin. The rest or remaining portion of the composition may contain other resins, such as polyhydroxybutyrate (PHB), or other biodegradable materials, nucleating agents, antioxidants, charge enhancers, or the like, or any combination thereof. In at least one implementation, the fiber may include 100% PLA resin.

In at least one implementation, the PLA fibers may include the one or more charge additives. In another embodiment, the filter media may include first fibers that may include PLA and second fibers that may include the charge additive. The second fibers may include any of the fibers described above. In yet another embodiment, both the PLA fibers and the second fibers may include the charge additive.

In at least one implementation, the filter media and/or the fibers thereof may include one or more nanoparticles. For example, the one or more nanoparticles may be incorporated into the substrate, the filter media, and/or the fibers thereof. The nanoparticles have at least one dimension less than 1 micron or less than 100 nm. The one or more nanoparticles may be capable of or configured to increase the overall surface area of the filter media, thereby increasing its filtration efficiency and allowing for the capture of submicron contaminants without significantly compromising other factors, such as pressure drop (i.e., air flow) through the filter. The nanoparticles may ensure that the efficiency of the filter media remains relatively high even after the electrostatic charge starts to decay over time. In addition, the bond between the fibers and the nanoparticles may be enhanced by the electrostatic charge, which allows the nanoparticles to be dispersed in depth throughout the filter media.

In at least one implementation, the nanoparticles are dispersed “in-depth” within the substrate or the fibers thereof. As used herein, the term “in-depth” means that the nanoparticles are dispersed beyond a first surface of the substrate such that at least some of the nanoparticles are disposed of between the first and second opposing surfaces into the internal structure of the substrate or media. In at least one implementation, the nanoparticles are substantially dispersed throughout the entire media from the first surface to the opposing second surface. In at least one implementation, the nanoparticles are dispersed through a portion of the media from the first surface to a location between the first and second surfaces.

The nanoparticles may be chosen with different triboelectric properties relative to the first and/or second fibers in order to use the triboelectric effect to further enhance particle removal. With this method, the generated nanoparticles may be formed in an electrical field and may be less subject to contamination by chemicals that may moderate the triboelectric effect. Nanoparticles with different adsorption properties or surface charge characteristics than the first and/or second fibers may also be used (e.g., in oil or water filtration). This difference may be used to enhance or create localized electrical field gradients within the filter media to enhance particle removal. The nanoparticles and/or the fibers may have different wetting characteristics.

The nanoparticles may be or include, but are not limited to, any suitable material, such as glass, biosoluble glass, ceramic materials, acrylic, carbon, metal, alumina, one or more polymers (e.g., nylon, polyethylene terephalate, and the like), polyvinyl chloride (PVC), polyolefin, polyacetal, polyester, cellulous ether, polyalkylene sulfide, poly (arylene oxide), polysulfone, modified polysulfone polymers, polyvinyl alcohol, polyamide, polystyrene (PS), polyacrylonitrile, polyvinylidene chloride, polymethyl methacrylate, polyvinylidene fluoride, or the like, or any combination thereof.

In at least one implementation, the nanoparticles may be coupled with or bonded to the fibers via mechanical entanglement. This mechanical bond may be supplemented with an adhesive or binding agent. In at least one implementation, the nanoparticles may not be crimped (i.e., they do not include significant wavy, bent, curled, coiled sawtooth or similar shape associated with the nanoparticle in a relaxed state). In at least one implementation, the nanoparticles may have a crimped body structure with a discrete length. For example, when these crimped nanofibers having a discrete length are attached to the fiber, they entangle among themselves and also with, onto, and around, the fiber with a firm attachment to form a modified fiber. In at least one implementation, the attachment of the nanofibers to the fibers may be accomplished via electrostatic charge attraction and/or Van der Waals force attraction between the fibers and the nanoparticles. A more complete description of filter media incorporating nanoparticles may be found in commonly assigned, co-pending U.S. provisional patent application Ser. No. 63/328,970, filed Apr. 8, 2022, the complete disclosure of which is incorporated herein by reference in its entirely for all purposes.

The following numbered paragraphs disclose one or more exemplary variations of the subject matter of the application:
1. A filter media, comprising a first plurality of fibers, wherein the first plurality of fibers comprises polylactic acid (PLA) fibers or acrylic fibers, wherein the first plurality of fibers are triboelectrically charged.
2. The filter media of paragraph 1, further comprising a second plurality of fibers, wherein the first plurality of fibers are triboelectrically charged with the second plurality of fibers.
3. The filter media of paragraph 2, wherein at least a portion of the second plurality of fibers comprises a tribonegative material.
4. The filter media of paragraph 2 or paragraph 3, wherein at least a portion of the second plurality of fibers comprises a tribopositive material, wherein the tribopositive material comprises a relatively lower positive charge than the first plurality of fibers.
5. The filter media of any one of paragraphs 2 to 4, wherein at least a portion of the second plurality of fibers comprises polypropylene (PP) fibers.
6. The filter media of paragraph 5, wherein the polypropylene fibers comprise an elongation of from about 25% to about 100%, a tenacity of from about 25 cN/tex to about 100 cN/tex, or a combination thereof.
7. The filter media of any one of paragraphs 1 to 5, wherein the first plurality of fibers comprise the acrylic fibers.
8. The filter media of any one of paragraphs 2 to 6, wherein the first plurality of fibers comprises the PLA fibers, and wherein at least a portion of the second plurality of fibers comprises acrylic fibers.
9. The filter media of any one of paragraphs 1 to 8, wherein the first plurality of fibers further comprise polyhydroxyalkanoate (PHBV).
10. The filter media of any one of paragraphs 2 to 9, wherein a weight ratio by weight of the first plurality of fibers to the second plurality of fibers is about 1:1.
11. The filter media of any one of paragraphs 2 to 10, wherein the first plurality of fibers and the second plurality of fibers are non-woven fibers.
12. The filter media of any one of paragraphs 1 to 11, wherein the first plurality of fibers are present in an amount of at least 10 wt %, based on the total weight of the filter media.
13. The filter media of any one of paragraphs 1 to 12, wherein the PLA fibers comprise poly L-lactide (PLLA).
14. The filter media of any one of paragraphs 1 to 13, wherein the first plurality of fibers, the second plurality of fibers, or a combination thereof comprise a spin finish of about 2% or lower.
15. The filter media of any one of paragraphs 1 to 14, wherein the first plurality of fibers comprise continuous fibers.
16. The filter media of any one of paragraphs 1 to 14, wherein the first plurality of fibers comprise non-continuous fibers.
17. The filter media of any one of paragraphs 1 to 16, wherein the first plurality of fibers have a diameter of from about 0.1 μm to about 200 μm.
18. The filter media of any one of paragraphs 1 to 17, wherein the first plurality of fibers have a linear density of about 0.5 Denier to about 50 Denier.
19. The filter media of any one of paragraphs 1 to 18, wherein the first plurality of fibers, the second plurality of fibers, or a combination thereof comprise one or more nucleating agents.
20. The filter media of any one of paragraphs 1 to 19, wherein the first plurality of fibers, the second plurality of fibers, or a combination thereof comprise one or more charge additives configured to modify a charge on the first plurality of fibers, increase a stability of a charge on the first plurality of fibers, or a combination thereof.
21. The filter media of paragraph 20, wherein the one or more charge additives comprise one or more of a triphenylmethane, an ammonium compound, an immonium compound, a fluorinated ammonium compound, a fluorinated immonium compounds, a biscationic acid amide, a polymeric ammonium compound, a diallylammonium compound, an arylsulfide derivative, a phenol derivative, a phosphonium compound, a fluorinated phosphonium compound, a calix(n)arene, a metal complex compound, a benzimidazolone, an azine, a thiazine, an oxazine, or any combination thereof
22. The filter media of paragraph 20 or 21, wherein the one or more charge additives comprise a nucleating agent.
23. The filter media of any one of paragraphs 19 to 22, wherein the one or more charge additives comprise an electronegative charge relatively greater than the first plurality of fibers or the second plurality of fibers.
24. The filter media of any one of paragraphs 19 to 23, wherein the one or more charge additives comprise a dielectric constant relatively greater than the first plurality of fibers or the second plurality of fibers.
25. The filter media of any one of paragraphs 1 to 24, wherein the first plurality of fibers comprises one or more charge control agents.
26. The filter media of any one of paragraphs 1 to 25, wherein the filter media is formed by carding and needling.
27. The filter media of any one of paragraphs 2 to 26, wherein the first plurality of fibers and the second plurality of fibers comprise spun bond charged media.
28. The filter media of any one of paragraphs 2 to 27, wherein the first plurality of fibers and the second plurality of fibers comprises melt blown charged media.
29. The filter media of any one of paragraphs 1 to 27, wherein the first plurality of fibers are triboelectrically charged by rubbing the first plurality of fibers with one or more machines, wherein the one or more machines comprise one or more of a carding machine, a needling machine, or a combination thereof
30. The filter media of any one of paragraphs 1 to 28, wherein the first plurality of fibers comprise the PLA fibers, and wherein the first plurality of fibers are triboelectrically charged by hydrocharging.
31. The filter media of any one of paragraphs 2 to 30, wherein the second plurality of fibers comprise one or more biodegradable fibers.
32. The filter media of paragraph 31, wherein the one or more biodegradable fibers comprises one or more of poly(3-hydroxybutyrate-co-3-hydroxyhexanoate) (PHBH), polyhydroxybutyrate (PHB), polybutylene succinate (PBS), poly(butyleneadipate-co-terephthalate) (PBAT), poly(3-hydroxybutyrate-co-e-hydroxyvalerate) (PHBV), polyhydroxyalkanoate (PHA), polycaprolactone (PCL), or any combination thereof.
33. The filter media of paragraph 31 or 32, wherein the one or more biodegradable fibers are selected from the group consisting of poly(3-hydroxybutyrate-co-3-hydroxyhexanoate) (PHBH), polyhydroxybutyrate (PHB), polybutylene succinate (PBS), poly(butyleneadipate-co-terephthalate) (PBAT), poly(3-hydroxybutyrate-co-e-hydroxyvalerate) (PHBV), polyhydroxyalkanoate (PHA), polycaprolactone (PCL), and combinations thereof
34. The filter media of any one of paragraphs 31 to 33, wherein the one or more biodegradable fibers comprises PHBH.
35. An air filter product, comprising the filter media of any one of paragraphs 1 to 34.
36. A method for manufacturing a filter media, the method comprising contacting a first plurality of fibers comprising polylactic acid (PLA) fibers or acrylic fibers with a second plurality of fibers, wherein contacting the first plurality of fibers with the second plurality of fibers triboelectrically charges the first plurality of fibers.
37. The method of paragraph 36, wherein the second plurality of fibers comprises a tribonegative material.
38. The method of paragraph 36, wherein the second plurality of fibers comprises a tribopositive material, wherein the tribopositive material comprises a relatively lower positive charge than the first plurality of fibers.
39. The method of paragraph 36, wherein the second plurality of fibers comprises polypropylene (PP).
40. The method of paragraph 39, wherein the first plurality of fibers comprises the acrylic fibers.
41. The method of paragraph 36, wherein the first plurality of fibers comprises the PLA fibers, and wherein the second plurality of fibers comprises acrylic fibers.
42. The method of any one of paragraphs 36 to 41, wherein the first plurality of fibers further comprises polyhydroxyalkanoate (PHBV).
43. The method of any one of paragraphs 36 to 42, wherein a weight ratio of the first plurality of fibers to the second plurality of fibers is about 1:1.
44. The method of any one of paragraphs 36 to 43, wherein the first plurality of fibers and the second plurality of fibers are non-woven fibers.
45. The method of any one of paragraphs 36 to 44, wherein the filter media comprises the PLA fibers in an amount of at least 50 wt %.
46. The method of any one of paragraphs 36 to 45, wherein the PLA fibers comprise poly L-lactide (PLLA).
47. The method of any one of paragraphs 36 to 46, further comprising carding the first plurality of fibers and the second plurality of fibers.
48. The method of any one of paragraphs 36 to 47, further comprising spun bonding the first plurality of fibers and the second plurality of fibers.
49. The method of any one of paragraphs 36 to 47, further comprising melt blowing the first plurality of fibers and the second plurality of fibers.
50. The method of any one of paragraphs 36 to 49, further comprising contacting one or more nucleating agents with the first plurality of fibers, the second plurality of fibers, or a combination thereof
51. The method of any one of paragraphs 36 to 50, further comprising contacting one or more charge additives with the first plurality of fibers, the second plurality of fibers, or a combination thereof
52. The method of any one of paragraphs 36 to 51, further comprising contacting one or more charge control agents with the first plurality of fibers, the second plurality of fibers, or a combination thereof
53. An air filter product prepared according to the method of any one of paragraphs 36 to 52.

### EXAMPLES

The examples and other implementations described herein are exemplary and not intended to be limiting in describing the full scope of compositions and methods of this disclosure. Equivalent changes, modifications, and variations of specific implementations, materials, compositions, and methods may be made within the scope of the present disclosure, with substantially similar results.

### Example 1

Exemplary fiber blends (1)-(3) including a blend of a first plurality of fibers and a second plurality of fibers were prepared and evaluated for their respective efficacy in filtering particles from air passing therethrough. Particularly, each of the fiber blends (1)-(3) was evaluated to determine the average penetration of particles passing therethrough. It should be appreciated that a relatively greater or increased penetration of the particles through a filter media and/or a fiber blend thereof indicates a relatively less effective filter media and/or fiber blend. Each of the fiber blends (1)-(3) included the first plurality of fibers and the second plurality of fibers in a 1:1 weight ratio (50 wt % to 50 wt %). All of the fibers were conditioned at about 30% relative humidity (RH) for at least three days prior to carding. The fibers were pre-weighted and hand-blended, and subsequently carded and needled to prepare the fiber blends. The dimensions of the fiber blends (1)-(3) were about 10″×10″ (about 25.4 cm×about 25.4 cm).

The first fiber blend (1) included a blend of acrylic fibers and polypropylene (PP) fibers. The second fiber blend (2) included a blend of PLA fibers and acrylic fibers. The third fiber blend (3) included a blend of PLA fibers and PP fibers. The PLA fibers did not have a spin finish (i.e., finish-free).

The particle penetration was evaluated or measured with an ATI 100S device with 0.3 μm particles at least three days after needling. The fiber blends (1)-(3) were evaluated with the ATI 100S device at 85 liters per minute (lpm) and 32 lpm. The average resistance of each of the fiber blends (1)-(3) was also evaluated/measured. It should be appreciated that triboelectric charging of the fibers occurred during the carding and/or needling processes. The basis weight for each of the fiber blends (1)-(3) was measured in grams per square foot (gsf), grams per square meter (gsm), and ounces per square yard (osy). It should be appreciated that the observed values were normalized to 134 gsm for comparison. Each of the fiber blends (1)-(3) were evaluated in duplicate, and the results are summarized in Table 1 and Table 2, respectively.

TABLE 1

| | | | | Measured at 85 lpm | | Measured at 32 lpm | |
|---|---|---|---|---|---|---|---|
| Fiber | Basis Weight | | | Avg. | Avg. | Avg. | Avg. |
| Blend | GSF | GSM | OSY | Penetration | Resistance | Penetration | Resistance |
| (1) | 12.01 | 129.22 | 3.81 | 19.7 | 1.1 | 7.2 | 0.2 |
| (2) | 12.91 | 138.95 | 4.10 | 8.3 | 1.0 | 2.4 | 0.2 |
| (3) | 13.99 | 150.53 | 4.44 | 7.6 | 1.0 | 1.9 | 0.2 |

TABLE 2

| | | | | Measured at 85 lpm | | Measured at 32 lpm | |
|---|---|---|---|---|---|---|---|
| Fiber | Basis Weight | | | Avg. | Avg. | Avg. | Avg. |
| Blend | GSF | GSM | OSY | Penetration | Resistance | Penetration | Resistance |
| (1) | 10.50 | 113.00 | 3.33 | 56.5 | 1.1 | 32.7 | 0.6 |
| (2) | 12.65 | 136.09 | 4.02 | 10.2 | 0.9 | 2.3 | 0.4 |
| (3) | 14.10 | 151.72 | 4.48 | 5.5 | 1.0 | 0.9 | 0.5 |

As illustrated in Table 1, the particles penetrated the fiber blend (1), including acrylic fibers and PP fibers, about 19.7% at about 85 lpm and about 7.2% at about 32 lpm. The particles penetrated the fiber blend (2), including the acrylic fibers and the PLA fibers, about 8.3% at about 85 lpm and about 2.4% at about 32 lpm. Further, the particles penetrated the fiber blend (3) including the PP fibers and the PLA fibers, about 7.6% at about 85 lpm and about 1.9% at about 32 lpm. The average resistance of the fiber blend (1) was substantially the same as the average resistance of the remaining fiber blends (2) and (3). It should be appreciated that the average resistance is directly proportional to the pressure drop and inversely proportional to air permeability. As illustrated in Table 2, similar results were observed when evaluated in duplicate. As such, it was surprisingly and unexpected discovered that the fiber blends (2) and (3) incorporating PLA exhibited relatively greater filtration efficacy as compared to the fiber blend (1), which excluded PLA, without compromising air permeability and/or pressure drop.

### Example 2

The exemplary fiber blends (1)-(3) of Example 1 and another exemplary fiber blend (4) were evaluated for their respective efficacy in filtering particles from air passing therethrough. The fiber blend (4) was prepared by adding a charge additive, namely FWM 02, to the fiber blend (3). Particularly, the charge additive was added to the PP fibers and blended with PLA fibers in a 1:1 weight ratio to prepare the fiber blend (4). The efficacy was evaluated as discussed above with respect to Example 1. It should be appreciated that the observed values were normalized to 126 gsm for comparison. The results are summarized in Table 3.

TABLE 3

| | | | | Measured at 85 lpm | | Measured at 32 lpm | |
|---|---|---|---|---|---|---|---|
| Filter | Basis Weight | | | Avg. | Avg. | Avg. | Avg. |
| Media | GSF | GSM | OSY | Penetration | Resistance | Penetration | Resistance |
| (1) | 10.60 | 114.01 | 3.36 | 57.5 | 0.6 | 37.4 | 0.6 |
| (2) | 13.07 | 140.62 | 4.15 | 17.4 | 0.6 | 5.1 | 0.5 |
| (3) | 12.06 | 129.73 | 3.83 | 15.3 | 0.6 | 4.2 | 0.5 |
| (4) | 12.09 | 130.09 | 3.84 | 16.0 | 0.4 | 4.9 | 0.5 |

As illustrated in Table 3, the average penetration of the particles in the fiber blend (4), including the charge additive, was similar to the penetration observed in the fiber blends (2) and (3). Further, while fiber blends (2)-(4) exhibited significantly less particle penetration as compared to fiber blend (1), the average resistance was substantially the same in each of the fiber blends (1)-(4). As such, it was surprisingly and unexpected discovered that the fiber blends (2)-(4) incorporating PLA exhibited relatively greater filtration efficacy as compared to the fiber blend (1), which excluded PLA, without compromising air permeability and/or pressure drop.

### Example 3

The efficacy of the fiber blends (1)-(3) of Example 1 was evaluated after aging for one week and two weeks. The results are summarized in Table 4, Table 5, and Table 6.

TABLE 4
Day 0

| | | | | Measured at 85 lpm | | Measured at 32 lpm | |
|---|---|---|---|---|---|---|---|
| Fiber | Basis Weight | | | Avg. | Avg. | Avg. | Avg. |
| Blend | GSF | GSM | OSY | Penetration | Resistance | Penetration | Resistance |
| (1) | 12.01 | 129.22 | 3.81 | 19.7 | 1.1 | 7.2 | 0.2 |
| (2) | 12.91 | 138.95 | 4.10 | 8.3 | 1.0 | 2.4 | 0.2 |
| (3) | 13.99 | 150.53 | 4.44 | 7.6 | 1.0 | 1.9 | 0.2 |

TABLE 5
Week 1

| | | | | Measured at 85 lpm | | Measured at 32 lpm | |
|---|---|---|---|---|---|---|---|
| Fiber | Basis Weight | | | Avg. | Avg. | Avg. | Avg. |
| Blend | GSF | GSM | OSY | Penetration | Resistance | Penetration | Resistance |
| (1) | 12.01 | 129.22 | 3.81 | 21.8 | 1.1 | 7.6 | 0.5 |
| (2) | 12.91 | 138.95 | 4.10 | 12.7 | 0.9 | 3.4 | 0.4 |
| (3) | 13.99 | 150.53 | 4.44 | 8.7 | 1.0 | 1.7 | 0.5 |

TABLE 6
Week 2

| | | | | Measured at 85 lpm | | Measured at 32 lpm | |
|---|---|---|---|---|---|---|---|
| Fiber | Basis Weight | | | Avg. | Avg. | Avg. | Avg. |
| Blend | GSF | GSM | OSY | Penetration | Resistance | Penetration | Resistance |
| (1) | 12.01 | 129.22 | 3.81 | 22.4 | 0.7 | 9.7 | 0.6 |
| (2) | 12.91 | 138.95 | 4.10 | 14.0 | 0.6 | 5.8 | 0.5 |
| (3) | 13.99 | 150.53 | 4.44 | 8.8 | 0.7 | 2.3 | 0.6 |

As illustrated in Tables 4-6, the efficacy and efficiency of the fiber blends (1)-(3) were substantially the same after one and two weeks. For example, after one week, the particles penetrated the fiber blend (1) about 21.8% at about 85 lpm and about 7.6 at 32 lpm (normalized values), the particles penetrated the fiber blend (2) about 12.7% at about 85 lpm and about 3.4% at about 32 lpm, and the particles penetrated the fiber blend (3) about 8.7% at about 85 lpm and about 1.7% at about 32 lpm. Similar results were observed after two weeks, as shown in Table 6.

### Example 4

Flat sheet filters (4)-(7) were prepared with triboelectrically charged media or triboelectrically charged fiber blends and evaluated for their filtering efficacy. The fiber blends were prepared in a 1:1 weight ratio, carded, and needle punch with varying scrims or supports. The PLA fibers were finish free or without a spin finish. The basis weight and the net fiber weight were substantially the same. The flat sheet filter (4) included a blend of PP fibers and acrylic fibers with a PP scrim. The flat sheet filter (5) included PLA fibers and acrylic fibers with a PP scrim. The flat sheet filter (6) included PLA fibers and acrylic fibers having antimicrobial and gas adsorption additives. The flat sheet filter (7) included PLA fibers and acrylic fibers with a PP scrim having a gas adsorption additive. The results

TABLE 7

| | | | | Average Air | | Net Fiber | | | | | Predicted |
|---|---|---|---|---|---|---|---|---|---|---|---|
| | Basis Weight | | | Permeation | Thickness | Weight | Pressure Drop | Particle Size | | | MERV |
| Filter | GSF | GSM | OSY | (CFM) | (mm) | (gsm) | (inches H₂O) | E1 | E2 | E3 | Rating |
| (4) | 8.71 | 93.71 | 2.77 | 349.5 | 78.3 | 80.2 | 0.202 | 53.1 | 86.6 | 94.7 | 13 |
| (5) | 8.73 | 93.93 | 2.77 | 331.5 | 83.3 | 80.4 | 0.171 | 66.5 | 90.9 | 95.9 | 13 |
| (6) | 9.62 | 103.51 | 3.05 | 378.2 | 70.0 | 79.0 | 0.185 | 55.0 | 87.4 | 95.4 | 13 |
| (7) | 9.23 | 99.26 | 2.93 | 350.2 | 71.7 | 80.3 | 0.191 | 69.7 | 93.0 | 97.2 | 13 |

As illustrated in Table 7, each of the filters (5)-(7), which incorporated PLA, exhibited improved filtration efficiency over the filter (4), which included the PP blend. The improvement was observed in all three particle sizes (E1=0.3-1 μm, E2=1-3 μm, and E3=3-10 μm). It was surprisingly and unexpectedly discovered that the improved filtering efficacy was observe while also exhibiting a lower pressure drop. In particular, the filters (5)-(7), which incorporated PLA, demonstrated a substantial improvement in particle size groups E1 and E2. For example, the filter (5), including PLA fibers and acrylic fibers with a PP scrim, increased filtration efficiency in the E1 group by over 13 points (i.e., 53.1 versus 66.5) and in the E2 group by over 4 points (i.e., 86.6 versus 90.9), while decreasing pressure drop by almost 15% (i.e., 0.202 versus 0.171). The filter (7), including PLA fibers and acrylic fibers with a PP scrim having a gas adsorption additive, exhibited increased filtration efficiency in the E1 group by over 16 points (i.e., 53.1 versus 69.7) and in the E2 group by almost 3 points (i.e., 94.7 versus 97.2), while decreasing pressure drop by almost 5% (i.e., 0.202 versus 0.1911).

### Example 5

Exemplary fiber blends (8) and (9) including a first plurality of fibers and a second plurality of fibers were prepared and evaluated. The fiber blend (8) included acrylic fibers and PP fibers with no spin finish, and the fiber blend (9) included PP fibers and acrylic fibers with a charge additive (i.e., FWM 02) and no spin finish. The basis weight and net fiber weight of the fiber blends (8) and (9) were substantially the same. The weight ratio of the acrylic fibers and the PP fibers in the fiber blends (8) and (9) were about 1:1. The linear density of each of the fiber blends (8) and (9) were substantially the same and were from about 1.7 deci-tex (dtex) to about 3.6 dtex. The charge additive was added to the fiber blend (9) during fiber spinning. The fiber blends were processed via needle punching to consolidate the fibers. Properties of the PP fibers with the charge additive and without the charge additive are summarized in Table 8.

TABLE 8

| | PP Fibers with | PP Fibers without |
|---|---|---|
| | Charge Additive | Charge Additive |
| Avg. Dtex | 2.59 | 2.46 |
| Tenacity (cN/tex) | 46.9 | 19.07 |
| Elongation (%) | 39 | 242 |
| Fiber Length (mm) | 51 | 59 |

As indicated in Table 8, the PP fibers utilized for the fiber blend (9), which included the charge additive, exhibited relatively less elongation as compared to the PP fibers utilized for the fiber blend (8). The PP fibers utilized for the fiber blend (9), which included the charge additive, also exhibited relatively greater tenacity as compared to the PP fibers utilized for the fiber blend (8). Without being bound by theory, it is believed that the relatively high tenacity and relatively low elongation resulted in the fibers being drawn more than the PP fibers without the charge additive. The relative increase in the drawing of the fibers is believed to affect crystallization. Particularly, the relative increase in the drawing of the fibers is believed to increase the amount or percentage of crystallization, thereby resulting in more ordered or oriented crystals, and the orientation of the crystals result in the relative increased efficacy of the fibers for generating and/or holding a triboelectric charge. It should be appreciated each of the PP fibers with and without the charge additive were evaluated with a scanning electron microscope (SEM) to observe physical attributes and morphologies thereof. The SEM micrographs illustrated that the PP fibers treated with the charge additive exhibited significantly greater surface roughness as compared to PP fibers without the charge additive. Without being bound by theory, it is believed that the increased surface roughness may, at least in part, contribute to the PP fibers efficacy for generating and holding or maintaining a triboelectric charge. The SEM micrographs also illustrated that the PP fibers treated with the charge additive exhibited relatively less alignment among the fibers and more curls, kinks, and turns, as compared to the PP fibers without the charge additive, which exhibited fibers significantly aligned or parallel with one another.

The fiber blends (8) and (9) were aged for three days. Ten hand sheets for each of the fiber blends (8) and (9) were evaluated with an ATI 100s device at 85 lpm and 32 lpm. The average penetration and resistance values were evaluated for 0.3 μm NaCl salt particles. The results are summarized in Table 9.

TABLE 9

| | | Measured at 85 lpm | | Measured at 32 lpm | |
|---|---|---|---|---|---|
| Fiber | | Avg. | Avg. | Avg. | Avg. |
| Blend | GSM | Penetration | Resistance | Penetration | Resistance |
| (8) | 95.3 | 14.9 | 0.8 | 4.1 | 0.4 |
| (9) | 95.3 | 8.6 | 0.9 | 1.9 | 0.4 |

As illustrated in Table 9, the fiber blend (9) exhibited relatively improved filtration performance as compared to fiber blend (8), which excluded the charge additive. It was surprising and unexpectedly discovered that the improved filtration did not compromise the resistance and pressure drop, which remained substantially the same. In particular, the particles penetrated about 14.9% of the fiber blend (8) and only about 8.6% of the fiber blend (9). At 32 LPM, the particles penetrated about 4.1% of fiber blend (8), while only penetrating about 1.9% of fiber blend (9), thereby providing greater than 200% increase in performance. The resistance (mmH₂O) of fiber blend (9) was substantially the same as fiber blend (8) at 32 LPM and only slightly higher at 85 LMP. Thus, fiber blend (9) exhibited increased filtration efficiency at substantially the same pressure drop as compared to fiber blend (8).

The hand sheets prepared from the fiber blends (8) and (9) were aged under controlled temperature and humidity. Particularly, the fiber blends (8) and (9) were aged at about 70° C. with about 80% RH for about 24 hours, and subsequently aged at about −20° C. for about 24 hours. The aged fiber blends (8) and (9) were then evaluated for their respective filtering efficacy. The results are summarized in Table 10.

TABLE 10

| | Measured at 85 lpm | | Measured at 32 lpm | |
|---|---|---|---|---|
| Aged | Avg. | Avg. | Avg. | Avg. |
| Fiber Blend | Penetration | Resistance | Penetration | Resistance |
| (8) | 25.1 | 0.6 | 13.3 | 0.3 |
| (9) | 19.7 | 0.6 | 9.6 | 0.3 |

As illustrated in Table 10, the fiber blend (9) exhibited a lower penetration of particles than the fiber blend (8) after aging and while substantially maintaining the same resistance. In particular, the average penetration of the fiber blend (9) was about 9.6% while the average penetration of the fiber blend (8) was about 13.3%.

### Example 6

Flat sheet filters (10) and (11) were prepared from the fiber blends (8) and (9), respectively, to evaluate the fractional filtering efficacy. Particularly, filter sheets (10) and (11) were prepared from the fiber blends (8) and (9), and measured at about 180 fpm air face velocity. The particles were KCl salt particles (diameter 0.3 μm to 10 μm). The results are summarized in Table 11.

TABLE 11

| | Basis | | | | | Predicted |
|---|---|---|---|---|---|---|
| | Weight | Pressure Drop | Particle Size | | | MERV |
| Filter | GSM | (inches H₂O) | E1 | E2 | E3 | Rating |
| (10) | 93.63 | 0.185 | 57.9 | 88.3 | 95.3 | 13 |
| (11) | 93.60 | 0.203 | 68.3 | 92.9 | 97.2 | 13 |

As illustrated in Table 11, the sheet filter (11) exhibited an improved filtration efficiency over the sheet filter (10) for all three particle sizes. While the pressure drop of the sheet filter (11) was relatively higher than the sheet filter (10), this pressure drop increase was commiserate with the decreased thickness of the sheet filter (11) (i.e., about 104.2 mm thickness for the sheet filter (11) versus about 111.7 mm thickness for the sheet filter (10)). In particular, of the sheet filter (11) exhibited a substantial improvement in particle size group E1 (about 57.9 versus about 68.3). Particle group E1 typically are related to charge density.

### Example 7

Exemplary fiber blends (12) and (13) including a blend of a first plurality of fibers including PLA fibers and a second plurality of fibers including poly(hydroxybutyrate-co-3-hexanoate) (PHBH) fibers were prepared and evaluated for their respective efficacy in filtering particles from air passing therethrough. Particularly, each of the fiber blends (12) and (13) was evaluated to determine the average penetration of particles passing therethrough. The PLA and PHBH fibers did not have a spin finish. The fiber blend (12) included the PLA fibers in an amount of about 50 wt % and the PHBH fibers in an amount of about 50 wt %. The fiber blend (13) included the PLA fibers in an amount of about 60 wt % and the PHBH fibers in an amount of about 40 wt %. All of the fibers were conditioned at about 30% relative humidity (RH) for at least three days prior to carding. The fibers were pre-weighted and hand-blended, and subsequently carded and needled to prepare the fiber blends (12) and (13). The dimensions of the fiber blends (12) and (13) were about 10″×10″ (about 25.4 cm×about 25.4 cm).

The fiber blends (12) and (13) were evaluated with the ATI 100S device at 85 liters per minute (lpm) and 32 lpm. The average resistance of each of the fiber blends (12) and (13) was also evaluated/measured. It should be appreciated that triboelectric charging of the fibers occurred during the carding and/or needling processes. The basis weight for each of the fiber blends (12) and (13) was measured in grams per square foot (gsf), grams per square meter (gsm), and ounces per square yard (osy). It should be appreciated that the observed values were normalized for comparison. The fiber blends (12) and (13) were evaluated on the day of production of about four days after. The results are summarized in Table 12.

TABLE 12

| | | | | | Measured at 85 lpm | | Measured at 32 lpm | |
|---|---|---|---|---|---|---|---|---|
| Fiber | | Basis Weight | | | Avg. | Avg. | Avg. | Avg. |
| Blend | Day | GSF | GSM | OSY | Penetration | Resistance | Penetration | Resistance |
| (12) | 0 | 13.0 | 139.8 | 4.1 | 46.2 | 0.6 | 23.8 | 0.4 |
| (12) | 4 | 13.0 | 139.8 | 4.1 | 48.6 | 1.0 | 32.0 | 0.4 |
| (13) | 4 | 17.54 | 188.72 | 5.57 | 39.5 | 1.4 | 21.9 | 0.4 |

As illustrated in Table 12, the difference in the average penetration between the flow rates of 85 lpm and 32 lpm supports that the PLA fibers of the fiber blends (12) and (13) are triboelectrically charged. Particularly, the average penetration at the lower flow rate of about 32 lpm exhibited a lower average penetration than the higher flow rate, which supports that the PLA fibers of the fiber blends (12) and (13) were triboelectrically charged. It is also demonstrated that the average penetration was substantially the same after aging for four days, thereby demonstrating that the PLA fibers retain the charge even after aging.

While the devices, systems, and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

1-53. (canceled)

54. A filter media, comprising a first plurality of fibers, wherein the first plurality of fibers comprises polylactic acid (PLA) fibers or acrylic fibers, wherein the first plurality of fibers are triboelectrically charged.

55. The filter media of claim 54, further comprising a second plurality of fibers, wherein the first plurality of fibers are triboelectrically charged with the second plurality of fibers.

56. The filter media of claim 55, wherein the second plurality of fibers comprises polypropylene (PP) fibers.

57. The filter media of claim 56, wherein the polypropylene fibers comprise an elongation of from about 25% to about 100%, a tenacity of from about 25 cN/tex to about 100 cN/tex, or a combination thereof.

58. The filter media of claim 54, further comprising a second plurality of fibers, wherein the first plurality of fibers are triboelectrically charged with the second plurality of fibers, and wherein the first plurality of fibers comprises the acrylic fibers and the second plurality of fibers comprises polypropylene fibers.

59. The filter media of claim 54, further comprising a second plurality of fibers, wherein the first plurality of fibers are triboelectrically charged with the second plurality of fibers, and wherein the first plurality of fibers comprises the PLA fibers, and wherein the second plurality of fibers comprises acrylic fibers.

60. The filter media of claim 54, wherein the first plurality of fibers further comprises polyhydroxyalkanoate (PHBV).

61. The filter media of claim 55, wherein a weight ratio by weight of the first plurality of fibers to the second plurality of fibers is about 1:1.

62. The filter media of claim 55, wherein the first plurality of fibers and the second plurality of fibers are non-woven fibers.

63. The filter media of claim 55, wherein the first plurality of fibers, the second plurality of fibers, or a combination thereof comprise a spin finish of about 2% or less.

64. The filter media of claim 54, wherein the first plurality of fibers comprises continuous fibers.

65. The filter media of claim 54, wherein the first plurality of fibers comprises non-continuous fibers.

66. The filter media of claim 54, further comprising one or more charge additives configured to modify a charge on the fibers of the filter media, increase a stability of a charge on the fibers of the filter media, or a combination thereof.

67. The filter media of claim 54, wherein the filter media is formed by carding and needling.

68. The filter media of claim 55, wherein the first plurality of fibers and the second plurality of fibers comprise spun bond charged media.

69. The filter media of claim 55, wherein the first plurality of fibers and the second plurality of fibers comprises melt blown charged media.

70. The filter media of claim 54, wherein the first plurality of fibers comprise the PLA fibers, and wherein the first plurality of fibers are triboelectrically charged by rubbing the first plurality of fibers with one or more machines, wherein the one or more machines comprise one or more of a carding machine, a needling machine, or a combination thereof.

71. The filter media of claim 54, wherein the first plurality of fibers comprise the PLA fibers, and wherein the first plurality of fibers are triboelectrically charged by hydrocharging.

72. The filter media of claim 55, wherein the first plurality of fibers comprise the PLA fibers, and wherein the second plurality of fibers comprise one or more biodegradable fibers.

73. A method for manufacturing the filter media of claim 55, the method comprising contacting the first plurality of fibers with the second plurality of fibers, wherein contacting the first plurality of fibers with the second plurality of fibers triboelectrically charges the first plurality of fibers.
